(19) United States
(12) Patent Application Publication
(10) Pub. No.: US 2013/0260611 A1
(43) Pub. Date: Oct. 3, 2013

(54) BATTERY MODULE

(71) Applicant: Jang-Gun AHN, Yongin-si (KR)

(72) Inventor: Jang-Gun AHN, Yongin-si (KR)

(21) Appl. No.: 13/559,364

(22) Filed: Jul. 26, 2012

Related U.S. Application Data
(60) Provisional application No. 61/619,675, filed on Apr. 3, 2012.

(51) Int. Cl. H01R 33/88

(52) U.S. Cl. 439/627

(57) ABSTRACT

A battery module includes a plurality of battery cells, each including a terminal having a fastening portion so as to provide a plurality of terminals and fastening portions, and a bus bar forcibly and insertably coupling the terminals of neighboring ones of the battery cells together through the fastening portions.

### CROSS-REFERENCE TO RELATED APPLICATION

The present application claims priority under 35 U.S.C. §119(e) to U.S. Provisional Application No. 61/619,675, filed on Apr. 3, 2012, and entitled “Battery Module”, which is incorporated herein by reference in its entirety.

### BACKGROUND

1. Field

Embodiments relate to a battery module, and more particularly, to a battery module having a terminal member.

2. Description of the Related Art

A high-power battery module using a non-aqueous electrolyte with high energy density has recently been developed. The high-power battery module may be configured as a large-capacity battery module manufactured by connecting a plurality of battery cells in series so as to be used in driving motors of devices requiring high power, e.g., electric vehicles and the like.

### SUMMARY

According to embodiments, there is provided a battery module including a plurality of battery cells, each including a terminal having a fastening portion so as to provide a plurality of terminals and fastening portions, and a bus bar forcibly and insertably coupling the terminals of neighboring ones of the battery cells together through the fastening portions.

The bus bar may include a bus bar main body that includes opposite ends. The opposite ends of the bus bar main body may have a shape corresponding to a shape of the fastening portion.

The fastening portion may have a rectangular shape in a section perpendicular to a direction of insertion of the bus bar. The bus bar main body may have a rectangular shape corresponding to the fastening portion.

The fastening portion may have a circular shape in a section perpendicular to a direction of insertion of the bus bar. The bus bar main body may have a circular shape corresponding to the fastening portion. The bus bar may be a hollow rod.

Each opposite end of the bus bar main body may include rib portions and groove portions between the rib portions.

The terminal may include a fastening window extending partially therethrough from a top portion of the terminal. Each opposite end of the bus bar main body may include one or more latching projections that engage the fastening window.

Each opposite end of the bus bar main body may include a single latching projection. The latching projection may project convexly toward the fastening window.

Each opposite end of the bus bar main body may include rib portions and groove portions between the rib portions. At least one of the rib portions may include a latching projection.

The bus bar may include a bus bar main body and an extending portion that extends outwardly from the bus bar main body. The extending portion may have a width that is greater than a width of the fastening portion.

Fastening portions of the neighboring ones of the battery cells may be oriented to face each other. The bus bar may extend in a line between the fastening portions.

Fastening portions of the neighboring ones of the battery cells may be oriented to face in a same direction. The bus bar may have substantially a U-shape such that opposite ends of extending portions of the bus bar constituting legs of the U-shape may insertably engage the fastening portions.

At least one of the battery cells may be coupled to two other neighboring battery cells, the fastening portion of the terminal of the at least one battery cell being oriented to couple a first one of the two other neighboring battery cells through a first bus bar and to couple a second one of the two other neighboring battery cells through a second bus bar.

The first bus bar and the second bus bar may be connected to each other within the fastening portion of the terminal of the at least one battery cell.

The first bus bar and the second bus bar may each have first and second opposite ends. The first opposite end of the first bus bar may be forcibly and insertably coupled to the second opposite end of the second bus bar within the fastening portion of the terminal of the at least one battery cell.

Each of the first and second opposite ends of the first bus bar and second bus bar may include fastening ribs and fastening grooves, the fastening ribs and fastening grooves of the first opposite ends being complementary to the fastening ribs and fastening grooves of the second opposite ends.

The first opposite end of the first bus bar may be a hollow rod. The second opposite end of the second bus bar may have a cylindrical outer circumference that corresponds to an inner circumference of the first opposite end of the first bus bar.

The battery module may further include a housing in which the battery cells are arranged. The housing may include end plates that face side surfaces of outermost ones of the battery cells and side plates that connect the end plates, the housing compressing the battery cells together.

Coupling of the terminals of neighboring ones of the battery cells together may be with the bus bar and with the compressing of the battery cells effected by the housing.

### BRIEF DESCRIPTION OF THE DRAWINGS

Features will become apparent to those of ordinary skill in the art by describing in detail exemplary embodiments with reference to the attached drawings in which:

FIG. 1 illustrates a perspective view of a battery module according to an embodiment.

FIG. 2A illustrates a perspective view of a terminal of the battery module of FIG. 1 and a bus-bar fastened to the terminal.

FIG. 2B illustrates an exploded perspective view of FIG. 2A.

FIGS. 3A to 3C illustrate enlarged perspective views showing bus-bars modified differently from the bus-bar illustrated in FIG. 2B.

FIG. 4 illustrates a perspective view of a battery module according to another embodiment.

FIG. 5A illustrates a perspective view of a terminal of the battery module of FIG. 4 and a bus-bar fastened to the terminal.

FIG. 5B illustrates an exploded perspective view of FIG. 5A.

FIG. 6 illustrates an enlarged perspective view showing a bus-bar modified differently from the bus-bar illustrated in FIG. 5B.

FIG. 7 illustrates a perspective view of a battery module according to another embodiment.

FIG. 8A illustrates a perspective view of a terminal of the battery module illustrated in FIG. 7 and a bus-bar fastened to the terminal.

FIG. 8B illustrates an exploded perspective view of FIG. 8A.

FIG. 9 illustrates a perspective view of a battery module according to another embodiment.

FIG. 10A illustrates a plan view of a terminal of the battery module illustrated in FIG. 9 and a bus-bar fastened to the terminal.

FIG. 10B illustrates an exploded perspective view showing a portion of FIG. 9.

FIG. 10C illustrates an enlarged perspective view showing a bus-bar according to the embodiment of FIG. 9.

FIG. 11 illustrates a perspective view of a battery module according to another embodiment.

FIG. 12A illustrates a perspective view of a terminal of the battery module illustrated in FIG. 11 and a bus-bar fastened to the terminal.

FIG. 12B illustrates an exploded perspective view of FIG. 12A.

### DETAILED DESCRIPTION

In the following detailed description, only certain exemplary embodiments have been shown and described, simply by way of illustration. As those skilled in the art would realize, the described embodiments may be modified in various different ways, all without departing from the spirit or scope. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

Exemplary embodiments will be described with reference to the accompanying drawings.

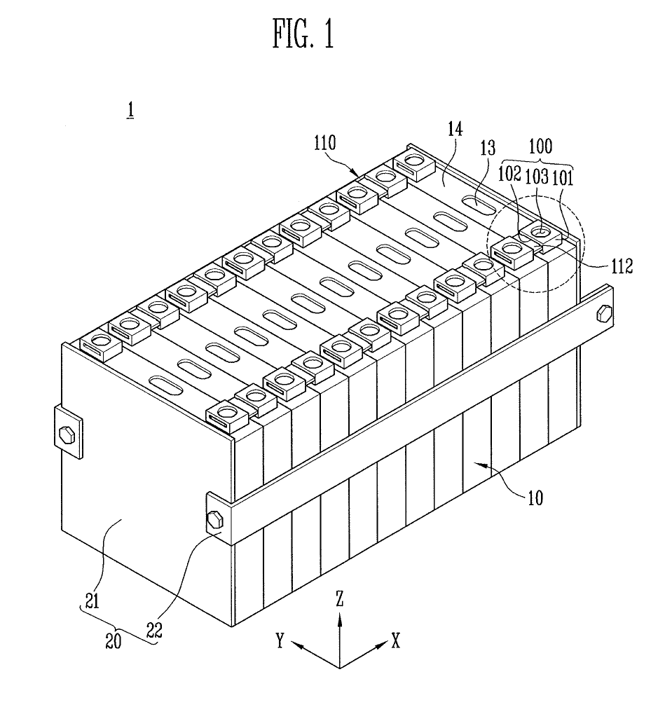

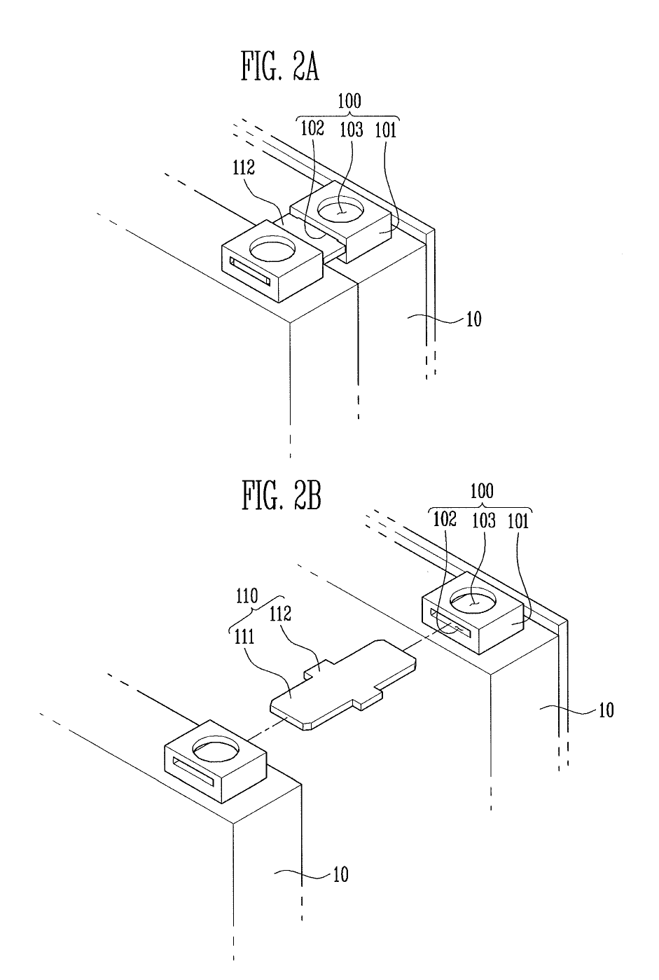

FIG. 1 is a perspective view of a battery module according to an embodiment. FIG. 2A is a perspective view illustrating a terminal of the battery module of FIG. 1 and a bus-bar fastened to the terminal. FIG. 2B is an exploded perspective view of FIG. 2A.

Referring to FIG. 1, the battery module 1 according to the present embodiment includes a plurality of battery cells 10, a terminal 100 provided on the each of the battery cells 10 and having a fastening portion 102, and a bus-bar 110 fastened to the fastening portions 102 of neighboring battery cells 10 so that the neighboring battery cells 10 are electrically connected to each other.

The battery cell 10 may include a battery case having one opened surface, and an electrode assembly and an electrolyte accommodated in the battery case to generate energy by an electrochemical reaction. The battery case may be sealed by a cap plate 14. The cap plate 14 may be provided with the terminal 100, the bus-bar 110 fastened to the terminal 100, and a vent portion 13. The terminal 100 may include positive and negative electrode terminals having different polarities from each other. The vent portion 13 may be a safety device of the battery cell 10, and may act as a path through which gas generated in the inside of the battery cell 10 is exhausted to the outside of the battery cell 10. The positive and negative electrode terminals of the neighboring battery cells 10 may be electrically connected to each other through the bus-bar 110.

The plurality of battery cells 10 may be aligned, and a housing 20 may be used to fix the alignment of the battery cells 10. The housing 20 may include end plates 21 and side plates 22. The end plates 21 may be provided opposite to each other, so that each of the end plates 21 faces a long side surface that is a wide surface of an outermost battery cell 10. The side plates 22 may connect the end plates 21 facing the respective outermost battery cells 10, and each of the side plates 22 may face short side surfaces that are narrow surfaces of the battery cells 10. The end plates 21 and the side plates 22 may be used to fix the plurality of battery cells 10, and may be variously modified depending on the design of the battery module 1.

The bus-bar 110 according to the present embodiment may be coupled to the terminal 100 through forcible insertion coupling. In this case, it is not necessary to connect the bus-bar 110 and the terminal 100 by a fastener such as a bolt and a nut or by a method such as welding. The battery cells 10 may be fixed by the housing 20 including the end plates 21 and the side plates 22, and thus the coupling force between the bus-bar 110 and the terminal 100 may be firmly maintained. After the bus-bar 110 and the terminal 100 are coupled to each other, the bus-bar 110 and the terminal 100 may be additionally welded, if desired.

Referring to FIGS. 2A and 2B, the terminal 100 according to the present embodiment may include a terminal main body 101, the fastening portion 102 to which the bus-bar 110 is fastened, and a fastening window 103 forming an opening connected to the fastening portion 102 so as to check a fastening state between the bus-bar 100 and the fastening portion 102. The section of the fastening portion 102 in parallel with the gravity direction may be formed in a rectangular shape, and the bus-bar 110 fastened to the fastening portion 102 may be formed in the shape of a bar corresponding to the fastening portion 102. As used herein, the term “gravity direction” refers to a direction between the terminals 100 of the battery cells and a base of the battery cells 10 along the z-axis shown in FIG. 1, regardless of the actual orientation of the battery cells. The fastening portion 102 may have a rectangular shape in a section perpendicular to a direction of insertion of the bus-bar 110 (in a direction along the x-axis shown in FIG. 1).

The bus-bar 110 coupled to the terminal 100 may include a bus-bar main body 111 and an extending portion 112 extended from the bus-bar main body 111 so as to be provided between the terminals 100. The extending portion 112 may serve as a kind of stop, and the length of the bus-bar main body 111 substantially fastened to the fastening portion 102 may be adjusted due to the extending portion 112.

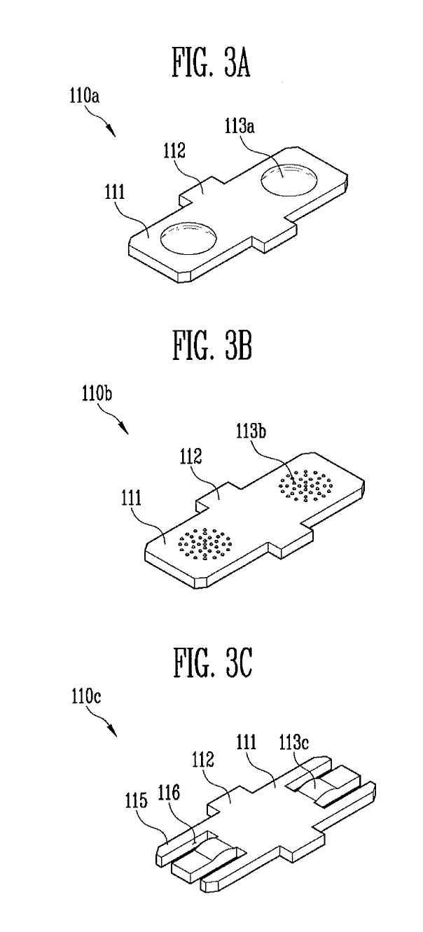

Hereinafter, bus-bars modified differently from the bus-bar illustrated in FIGS. 1 to 2B will be described with reference to FIGS. 3A to 3C.

Referring to FIG. 3A, the bus-bar 110a may include a first latching projection 113a on the bus-bar main body 111, the first latching projection having a shape corresponding to the fastening window 103. The first latching projection 113a may be formed in a shape that is convex in an upward direction, such as a convex lens shape.

Referring to FIG. 3B, the bus-bar 110b may include a second latching projection 113b on a bus-bar main body 111 in a region corresponding to the fastening window. The second latching projection 113b may be formed to be composed of a plurality of projections.

Referring to FIG. 3C, the bus-bar 110c may include a fastening groove 116 between fastening ribs 115 in at least a portion of a bus-bar main body 111. A third latching projection 113c exposed to the fastening window 103 may be further provided on the fastening rib 115.

The first, second or third latching projection 113a, 113b or 113c shown in FIGS. 3A to 3C may be accommodated in a space secured by the fastening window 103 connected to the fastening portion 102.

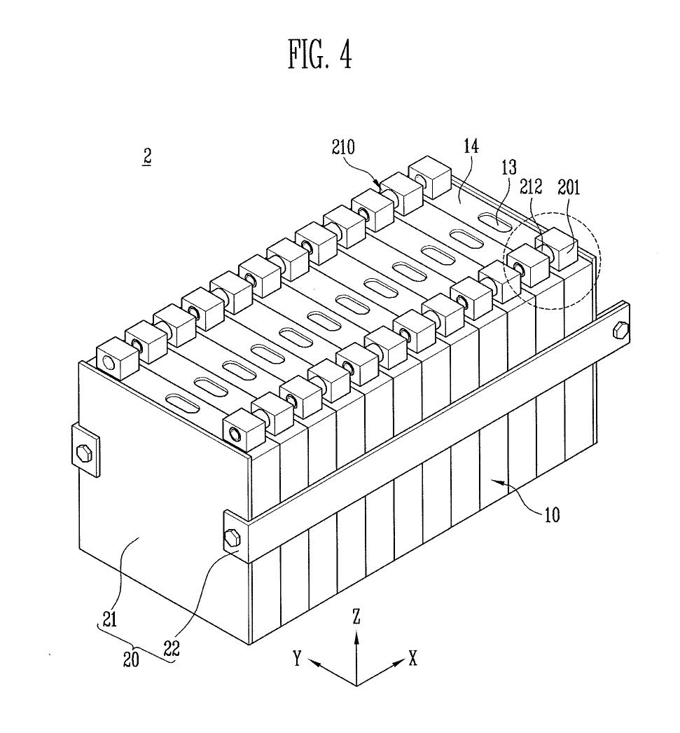

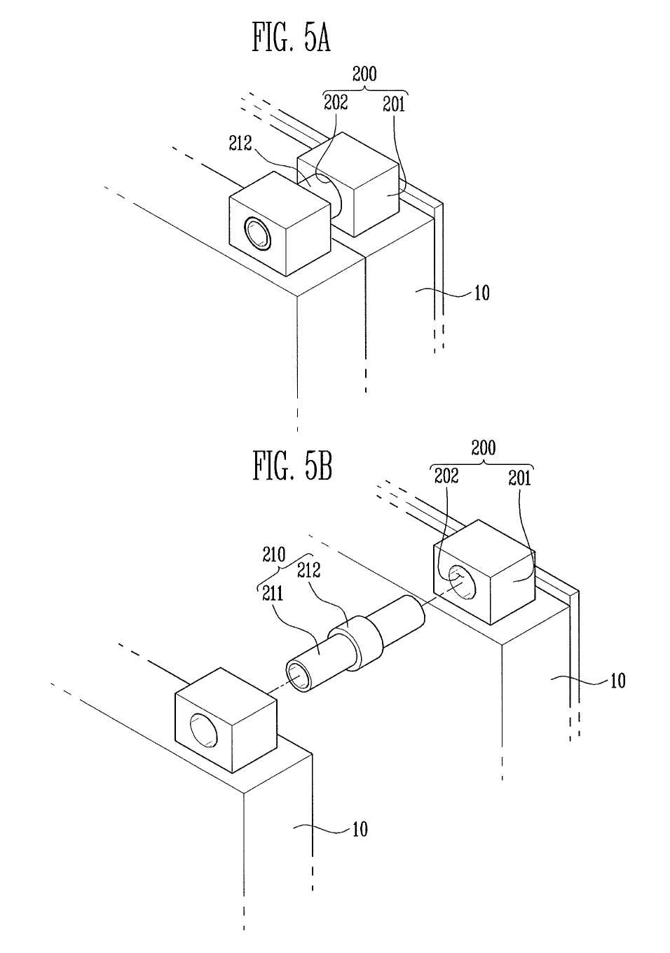

Hereinafter, a battery module according to another embodiment will be described with reference to FIGS. 4 to 5B. In this embodiment, descriptions of components identical or similar to those of the previous embodiment will not be repeated, and only components different from those of the previous embodiment illustrated in FIG. 1 will be described.

FIG. 4 is a perspective view of a battery module according to the present embodiment. FIG. 5A is a perspective view illustrating a terminal of the battery module of FIG. 4 and a bus-bar fastened to the terminal. FIG. 5B is an exploded perspective view of FIG. 5A.

Referring to FIG. 4, the battery module 2 according to the present embodiment includes a plurality of battery cells 10, a terminal 200 provided on each of the battery cells 10 and having a fastening portion 202, and a bus-bar 210 fastened to the fastening portions 202 of neighboring battery cells 10 so that the neighboring battery cells 10 are electrically connected to each other.

The battery cell 10 may include a battery case having one opened surface, and an electrode assembly and an electrolyte accommodated in the battery case to generate energy by an electrochemical reaction. The battery case may be sealed by a cap plate 14. The cap plate 14 may be provided with the terminal 200, the bus-bar 210 fastened to the terminal 200, and a vent portion 13. The terminal 200 may include positive and negative electrode terminals having different polarities from each other. The vent portion 13 may be safety device of the battery cell 10, and may act as a path through which gas generated in the inside of the battery cell 10 is exhausted to the outside of the battery cell 10. The positive and negative electrode terminals of the neighboring battery cells 10 may be electrically connected to each other through the bus-bar 210.

The bus-bar 210 according to the present embodiment may be coupled to the terminal 200 through forcible insertion coupling. In this case, it is not necessary to connect the bus-bar 210 and the terminal 200 by a fastener such as a bolt and a nut or by a method such as welding, The battery cells 10 may be fixed by the housing 20 including the end plates 21 and the side plates 22, and thus the coupling force between the bus-bar 210 and the terminal 200 may be firmly maintained. After the bus-bar 210 and the terminal 200 are coupled to each other, the bus-bar 210 and the terminal 200 may be additionally welded, if desired.

Referring to FIGS. 5A and 5B, the terminal 200 according to the present embodiment may include a terminal main body 201 and the fastening portion 202 to which the bus-bar 210 is fastened. The section of the fastening portion 202 in parallel with the gravity direction of the bus bar may be formed in a circular shape, and the bus-bar 210 fastened to the fastening portion 202 may be formed in the shape of a hollow rod corresponding to the fastening portion 202. The fastening portion 202 may have a circular shape in a section perpendicular to a direction of insertion of the bus-bar 210 (in a direction along the x-axis shown in FIG. 4).

The bus-bar 210 coupled to the terminal 200 may include a bus-bar main body 211 and an extending portion 212 extended from the bus-bar main body 211 so as to be provided between the terminals 200. The extending portion 212 may serve as a kind of stop, and the length of the bus-bar main body 211 substantially fastened to the fastening portion 202 may be adjusted due to the extending portion 212.

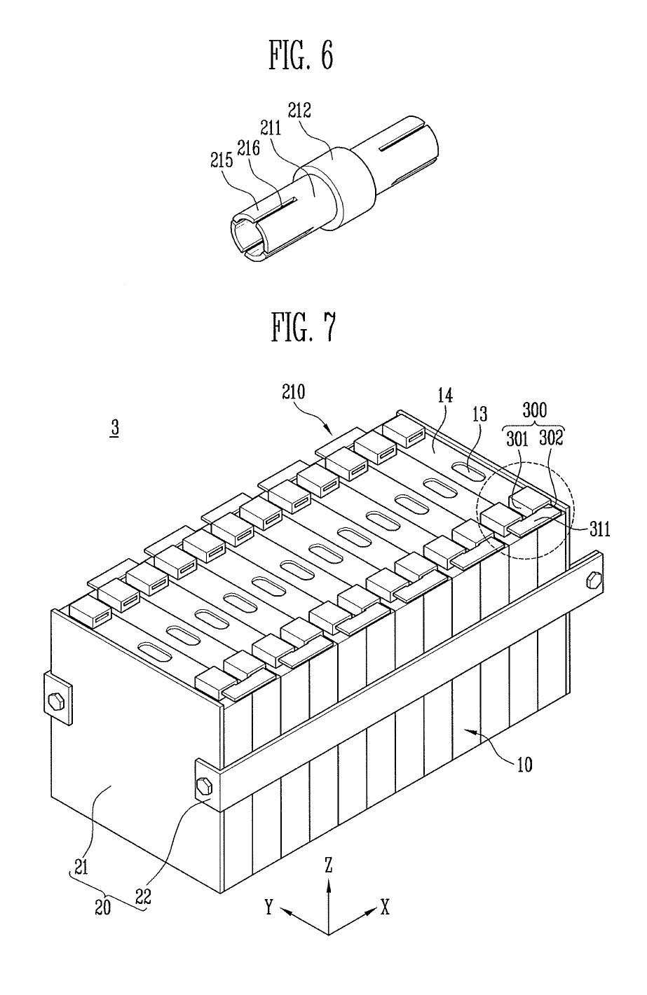

Hereinafter, a bus-bar modified differently from the bus-bar illustrated in FIGS. 4 to 5B will be described with reference to FIG. 6.

A fastening groove 216 provided between fastening ribs 215 may be formed in at least a portion of the bus-bar main body 211. The bus-bar main body 211 may be flexibly fastened to the terminal 200 due to the fastening groove 216 provided between the fastening ribs 215.

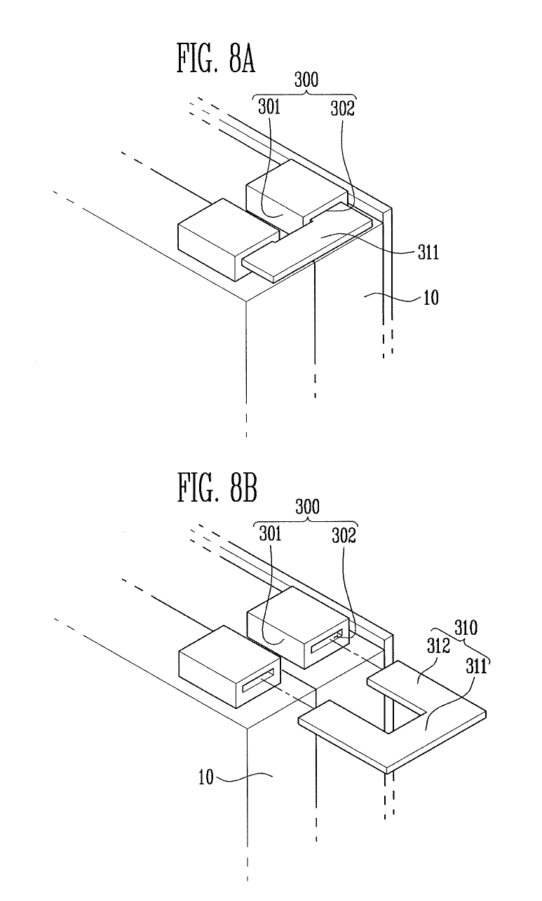

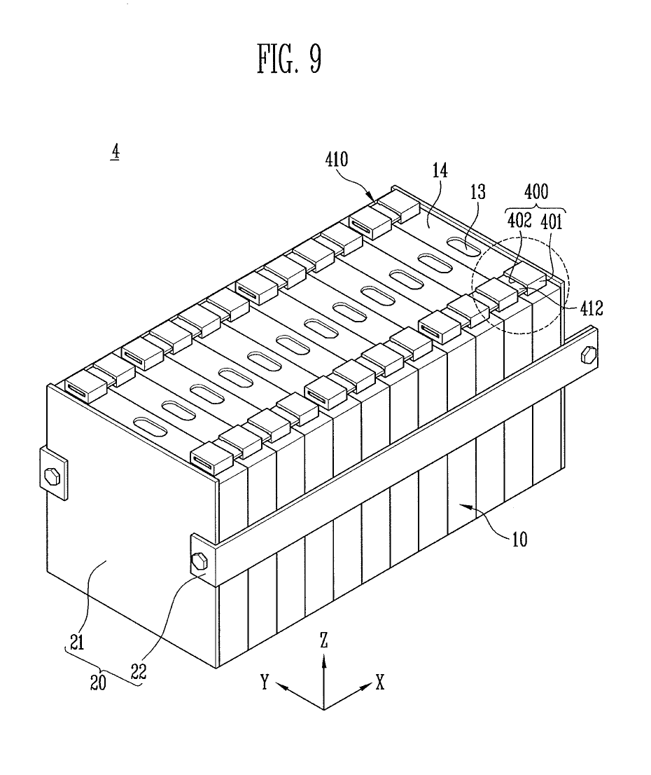

Hereinafter, a battery module according to another embodiment will be described with reference to FIGS. 7 to 8B. In this embodiment, descriptions of components identical or similar to those of the previous embodiments will not be repeated, and only components different from those of the previous embodiments will be described.

FIG. 7 is a perspective view of a battery module according to the present embodiment. FIG. 8A is a perspective view illustrating a terminal of the battery module of FIG. 7 and a bus-bar fastened to the terminal. FIG. 8B is an exploded perspective view of FIG. 8A.

Referring to FIG. 7, the battery module 3 according to the present embodiment includes a plurality of battery cells 10, a terminal 300 provided on each of the battery cells 10 and having a fastening portion 302, and a bus-bar 310 fastened to the fastening portions 302 of neighboring battery cells 10 so that the neighboring battery cells 10 are electrically connected to each other.

The battery cell 10 may include a battery case having one opened surface, and an electrode assembly and an electrolyte accommodated in the battery case to generate energy by an electrochemical reaction. The battery case may be sealed by a cap plate 14. The cap plate 14 may be provided with the terminal 300, the bus-bar 310 fastened to the terminal 300, and a vent portion 13. The terminal 300 may include positive and negative electrode terminals having different polarities from each other. The vent portion 13 may be a safety device of the battery cell 10, and may act as a path through which gas generated in the inside of the battery cell 10 is exhausted to the outside of the battery cell 10. The positive and negative electrode terminals of the neighboring battery cells 10 may be electrically connected to each other through the bus-bar 310.

The bus-bar 310 according to the present embodiment may be coupled to the terminal 300 through forcible insertion coupling. In this case, it is not necessary to connect the bus-bar 310 and the terminal 300 by a fastener such as a bolt and a nut or by a method such as welding, The battery cells 10 may be fixed by the housing 20 including the end plates 21 and the side plates 22, and thus the coupling force between the bus-bar 310 and the terminal 300 may be firmly maintained. After the bus-bar 310 and the terminal 300 are coupled to each other, the bus-bar 310 and the terminal 300 may be additionally welded, if desired.

Referring to FIGS. 8A and 8B, the terminal 300 according to the present embodiment includes a terminal main body 301 and the fastening portion 302 to which the bus-bar 310 is fastened. Here, the section of the fastening portion 302 in parallel with the gravity direction is formed in a rectangular shape, and the bus-bar 310 fastened to the fastening portion 302 is formed in the shape of a bar corresponding to the fastening portion 302. The fastening portion 302 may have a rectangular shape in a section perpendicular to a direction of insertion of the bus-bar 310 (in a direction along the y-axis shown in FIG. 7).

The bus-bar 310 coupled to the terminals 300 may include a bus-bar main body 311 and extending portions 312 respectively extended from both sides of the bus-bar main body 311 so as to be fastened to the fastening portions 302 of the terminals 300. The extending portion 312 may serve as a kind of stop, and the length of the bus-bar main body 311 substantially fastened to the fastening portion 302 may be adjusted due to the extending portion 312. The bus-bar 310 may be fastened to the fastening portion 302 on the short side surface of the battery cell 10 so as to facilitate the fastening between the bus-bar 310 and the fastening portion 302.

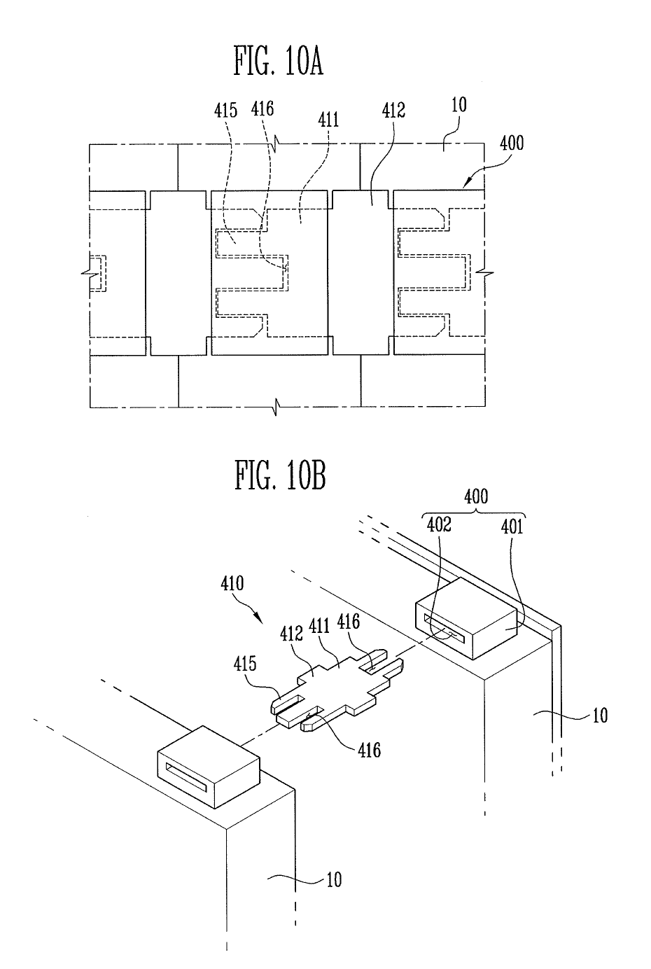

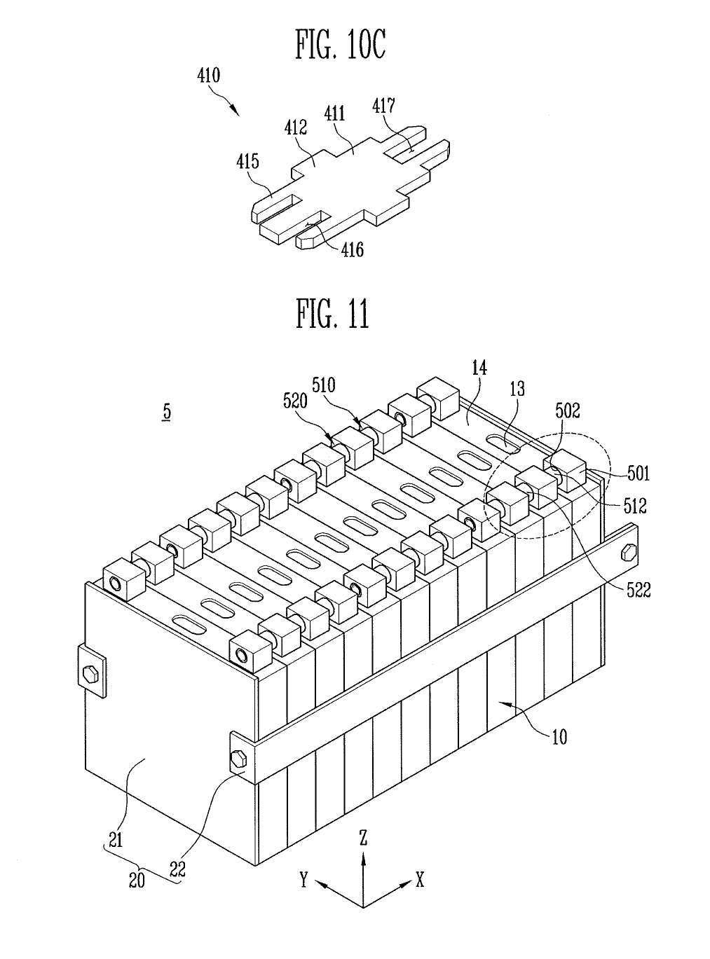

Hereinafter, a battery module according to another embodiment will be described with reference to FIGS. 9 to 10B. In this embodiment, descriptions of components identical or similar to those of the previous embodiments will not be repeated, and only components different from those of the previous embodiments will be described.

FIG. 9 is a perspective view of a battery module according to the present embodiment. FIG. 10A is a plan view illustrating a terminal of the battery module of FIG. 9 and a bus-bar fastened to the terminal. FIG. 10B is an exploded perspective view showing a portion of FIG. 9.

Referring to FIG. 9, the battery module 4 according to the present embodiment includes a plurality of battery cells 10, a terminal 400 provided on each of the battery cells 10 and having a fastening portion 402, and a bus-bar 410 fastened to the fastening portions 402 of neighboring battery cells 10 so that the neighboring battery cells 10 are electrically connected to each other.

The battery cell 10 may include a battery case having one opened surface, and an electrode assembly and an electrolyte accommodated in the battery case to generate energy by an electrochemical reaction. The battery case may be sealed by a cap plate 14. The cap plate 14 may be provided with the terminal 400, the bus-bar 410 fastened to the terminal 400, and a vent portion 13. The terminal 400 may include positive and negative electrode terminals having different polarities from each other. The vent portion 13 may be a safety device of the battery cell 10, and may act as a path through which gas generated in the inside of the battery cell 10 is exhausted to the outside of the battery cell 10. The positive and negative electrode terminals of the neighboring battery cells 10 may be electrically connected to each other through the bus-bar 410.

The bus-bar 410 according to the present embodiment may be coupled to the terminal 400 through forcible insertion coupling. In this case, it is not necessary to connect the bus-bar 410 and the terminal 400 by a fastener such as a bolt and a nut or by a method such as welding. The battery cells 10 may be fixed by the housing 20 including the end plates 21 and the side plates 22, and thus the coupling force between the bus-bar 410 and the terminal 400 may be firmly maintained. After the bus-bar 410 and the terminal 400 are coupled to each other, the bus-bar 410 and the terminal 400 may be additionally welded, if desired.

Referring to FIGS. 10A, 10B, and 10C, the terminal 400 according to the present embodiment includes a terminal main body 401 and the fastening portion 402 to which the bus-bar 410 is fastened. The section of the fastening portion 402 in parallel with the gravity direction may be formed in a rectangular shape, and the bus-bar 410 may be fastened to the fastening portion 402. The fastening portion 402 may have a rectangular shape in a section perpendicular to a direction of insertion of the bus-bar 410 (in a direction along the x-axis shown in FIG. 9).

The bus-bar 410 coupled to the terminals 400 may include a bus-bar main body 411 and extending portions 412 respectively extended from both sides of the bus-bar main body 411 so as to be fastened to the fastening portions 402 of the terminals 400. The extending portion 412 may serve as a kind of stop, and the length of the bus-bar main body 411 substantially fastened to the fastening portion 402 may be adjusted due to the extending portion 412.

Fastening grooves 416 provided between fastening ribs 415 may be formed at both sides of the bus-bar main body 411 in the bus-bar 410. The fastening rib 415 and fastening groove 416 of neighboring bus-bar main bodies 411 may be complementarily coupled so that the neighboring bus-bar main bodies 411 are connected to each other. Referring to FIG. 10A, by coupling the neighboring bus bar bodies 411 to each other, the battery cells 10 may be connected to each other in parallel. Accordingly, referring to FIG. 9, by selective use of the bus-bar 410, the battery cells 10 may be connected in series, in parallel, or in a combination of series and parallel. The bus-bar main body 411 may be flexibly fastened to the terminal 400 due to the fastening groove 416 provided between the fastening ribs 415.

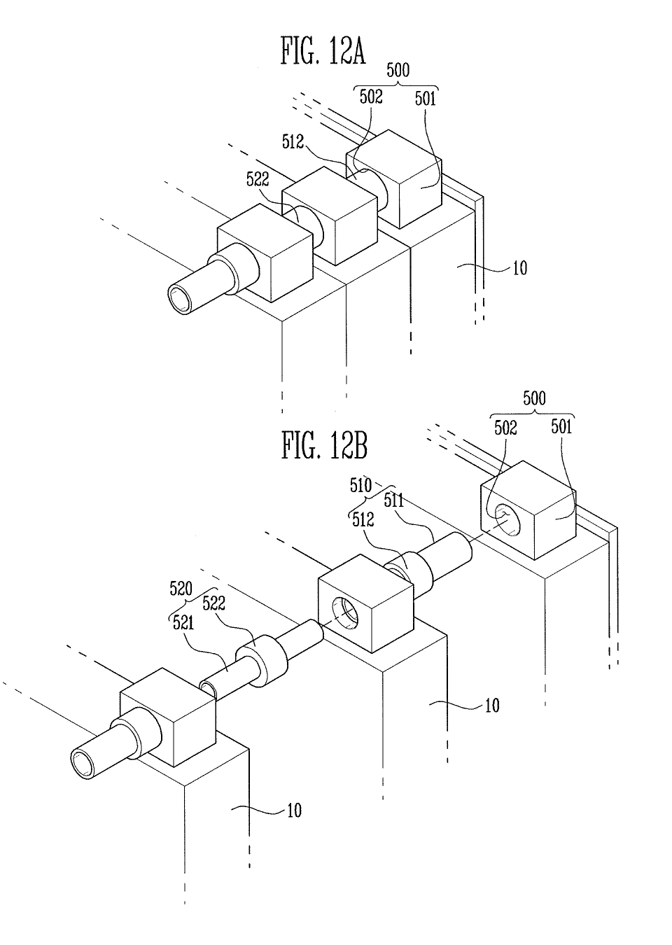

Hereinafter, a battery module according to another embodiment will be described with reference to FIGS. 11 to 12B. In this embodiment, descriptions of components identical or similar to those of the previous embodiments will not be repeated, and only components different from those of the previous embodiments will be described.

FIG. 11 is a perspective view of a battery module according to the present embodiment. FIG. 12A is a perspective view illustrating a terminal of the battery module of FIG. 11 and a bus-bar fastened to the terminal. FIG. 12B is an exploded perspective view of FIG. 12A.

Referring to FIG. 11, the battery module 5 according to the present embodiment includes a plurality of battery cells 10; a terminal 500 provided on each of the battery cells 10 and having a fastening portion 502; and a bus-bar 510 fastened to the fastening portions 502 of neighboring battery cells 10 so that the neighboring battery cells 10 are electrically connected to each other. An auxiliary bus-bar 520 may be connected between neighboring bus-bars 510.

The battery cell 10 may include a battery case having one opened surface, and an electrode assembly and an electrolyte accommodated in the battery case to generate energy by an electrochemical reaction. The battery case may be sealed by a cap plate 14. The cap plate 14 may be provided with the terminal 500, the bus-bar 510 fastened to the terminal 500, and a vent portion 13. The terminal 500 may include positive and negative electrode terminals having different polarities from each other. The vent portion 13 may be a safety device of the battery cell 10, and may act as a path through which gas generated in the inside of the battery cell 10 is exhausted to the outside of the battery cell 10. The positive and negative electrode terminals of the neighboring battery cells 10 may be electrically connected to each other through the bus-bar 510.

The bus-bar 510 according to the present embodiment may be coupled to the terminal 500 through forcible insertion coupling. In this case, it is not necessary to connect the bus-bar 510 and the terminal 500 by a fastener such as a bolt and a nut or by a method such as welding. The battery cells 10 may be fixed by the housing 20 including the end plates 21 and the side plates 22, and thus, the coupling force between the bus-bar 510 and the terminal 500 may be firmly maintained. After the bus-bar 510 and the terminal 500 are coupled to each other, the bus-bar 510 and the terminal 500 may be additionally welded, if desired.

Referring to FIGS. 12A and 12B, the terminal 500 according to the present embodiment includes a terminal main body 501 and the fastening portion 502 to which the bus-bar 510 is fastened. Here, the section of the fastening portion 502 in parallel with the gravity direction may be formed in a circular shape, and the bus-bar 510 fastened to the fastening portion 502 may be formed in the shape of a hollow rod corresponding to the fastening portion 502. The fastening portion 502 may have a circular shape in a section perpendicular to a direction of insertion of the bus-bar 510 (in a direction along the x-axis shown in FIG. 11).

The auxiliary bus-bar 520 connecting neighboring bus-bars 510 may further be provided between the neighboring bus-bars 510. The auxiliary bus-bar 520 may be formed in the shape of a hollow rod, corresponding to the bus-bar 510 neighboring thereto. Therefore, the auxiliary bus-bar 520 may be coupled to the bus-bar 510 neighboring thereto so that an auxiliary bus-bar main body 521 of the auxiliary bus-bar 520 is forcibly inserted into the inside of the bus-bar 510.

The bus-bar 510 coupled to the terminals 500 may include a bus-bar main body 511 and an extending portion 512 extended from the bus-bar main body 511 so as to be provided between the terminals 500. The auxiliary bus-bar 520 connecting the neighboring bus-bars 510 may also include an auxiliary bus-bar main body 521 and an auxiliary bus-bar extending portion 522 extended from the auxiliary bus-bar main body 521 so as to be provided between the terminals 500. Here, the extending portion 512 and the auxiliary bus-bar extending portion 522 may serve as a kind of stop, and the length of the bus-bar main body 511 substantially fastened to the fastening portion 502 may be adjusted due to the extending portion 512 and the auxiliary bus-bar extending portion 522. Referring to FIG. 12B, by coupling the bus-bar 510 and auxiliary bus-bar 520 to each other, the battery cells 10 may be connected in parallel. Accordingly, referring to FIG. 11, by selective use of the bus bar 510 and auxiliary bus-bar 520, the battery cells 10 may be connected in series, in parallel, or in a combination of series and parallel.

By way of summation and review, the battery module may include a plurality of battery cells, and neighboring battery cells are electrically connected by a bus-bar. A bus-bar may connect neighboring battery cells through a fastening structure such as a bolt and a nut, but a simpler fastening structure for the bus-bar is desirable.

Embodiments disclosed herein may provide a battery module capable of simplifying the fastening structure of a bus-bar through a simple structural modification. Embodiments may also provide a battery module capable of reducing production cost and improving processing efficiency.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope as set forth in the following claims.

What is claimed is:

1. A battery module comprising:
a plurality of battery cells, each including a terminal having a fastening portion so as to provide a plurality of terminals and fastening portions; and
a bus bar forcibly and insertably coupling the terminals of neighboring ones of the battery cells together through the fastening portions.

2. The battery module as claimed in claim 1, wherein:
the bus bar includes a bus bar main body that includes opposite ends, and
the opposite ends of the bus bar main body have a shape corresponding to a shape of the fastening portion.

3. The battery module as claimed in claim 2, wherein:
the fastening portion has a rectangular shape in a section perpendicular to a direction of insertion of the bus bar, and
the bus bar main body has a rectangular shape corresponding to the fastening portion.

4. The battery module as claimed in claim 2, wherein
the fastening portion has a circular shape in a section perpendicular to a direction of insertion of the bus bar, and
the bus bar main body has a circular shape corresponding to the fastening portion.

5. The battery module as claimed in claim 4, wherein the bus bar is a hollow rod.

6. The battery module as claimed in claim 2, wherein each opposite end of the bus bar main body includes rib portions and groove portions between the rib portions.

7. The battery module as claimed in claim 2, wherein the terminal includes a fastening window extending partially therethrough from a top portion of the terminal.

8. The battery module as claimed in claim 7, wherein each opposite end of the bus bar main body includes one or more latching projections that engage the fastening window.

9. The battery module as claimed in claim 8, wherein each opposite end of the bus bar main body includes a single latching projection, the latching projection projecting convexly toward the fastening window.

10. The battery module as claimed in claim 8, wherein each opposite end of the bus bar main body includes rib portions and groove portions between the rib portions, at least one of the rib portions including a latching projection.

11. The battery module as claimed in claim 1, wherein:
the bus bar includes a bus bar main body and an extending portion that extends outwardly from the bus bar main body, and
the extending portion has a width that is greater than a width of the fastening portion.

12. The battery module as claimed in claim 1, wherein:
fastening portions of the neighboring ones of the battery cells are oriented to face each other, and
the bus bar extends in a line between the fastening portions.

13. The battery module as claimed in claim 1, wherein:
fastening portions of the neighboring ones of the battery cells are oriented to face in a same direction, and
the bus bar has substantially a U-shape such that opposite ends of extending portions of the bus bar constituting legs of the U-shape insertably engage the fastening portions.

14. The battery module as claimed in claim 1, wherein at least one of the battery cells is coupled to two other neighboring battery cells, the fastening portion of the terminal of the at least one battery cell being oriented to couple a first one of the two other neighboring battery cells through a first bus bar and to couple a second one of the two other neighboring battery cells through a second bus bar.

15. The battery module as claimed in claim 14, wherein the first bus bar and the second bus bar are connected to each other within the fastening portion of the terminal of the at least one battery cell.

16. The battery module as claimed in claim 15, wherein;
the first bus bar and the second bus bar each have first and second opposite ends, and
the first opposite end of the first bus bar is forcibly and insertably coupled to the second opposite end of the second bus bar within the fastening portion of the terminal of the at least one battery cell.

17. The battery module as claimed in claim 16, wherein each of the first and second opposite ends of the first bus bar and second bus bar include fastening ribs and fastening grooves, the fastening ribs and fastening grooves of the first opposite ends being complementary to the fastening ribs and fastening grooves of the second opposite ends.

18. The battery module as claimed in claim 16, wherein;
the first opposite end of the first bus bar is a hollow rod,
the second opposite end of the second bus bar has a cylindrical outer circumference that corresponds to an inner circumference of the first opposite end of the first bus bar.

19. The battery module as claimed in claim 1, further including a housing in which the battery cells are arranged, the housing including end plates that face side surfaces of outermost ones of the battery cells and side plates that connect the end plates, the housing compressing the battery cells together.

20. The battery module as claimed in claim 19, wherein coupling of the terminals of neighboring ones of the battery cells together is with the bus bar and with the compressing of the battery cells effected by the housing.
